(19) United States
(12) Patent Application Publication
(10) Pub. No.: US 2016/0309730 A1
(43) Pub. Date: Oct. 27, 2016

(54) FRESH FOOD PRODUCE WRAPPED IN A FILM

(71) Applicant: DSM IP ASSETS B.V., Heerlen (NL)

(72) Inventor: Paul Willem Jan Van Den Heuvel, Echt (NL)

(21) Appl. No.: 15/102,095

(22) PCT Filed: Dec. 9, 2014
(86) PCT No.: PCT/EP2014/076961

§ 371 Date: Jun. 6, 2016

(30) Foreign Application Priority Data
Dec. 18, 2013 (EP) 13198055.9

(51) Int. Cl. A23B 7/16; B65D 75/26; B65D 85/34

(52) U.S. Cl. CPC A23B 7/16; B65D 85/34; B65D 75/26; A23V 2002/00; B65D 2565/388

(57) ABSTRACT

Fresh food produce wrapped in a film, characterized in that the film has a moisture vapour transmission rate (MVTR according to ISO 12572:2001, condition B at 1 bar, 38° C. and 50% relative humidity) of at least 350 g/m²·day

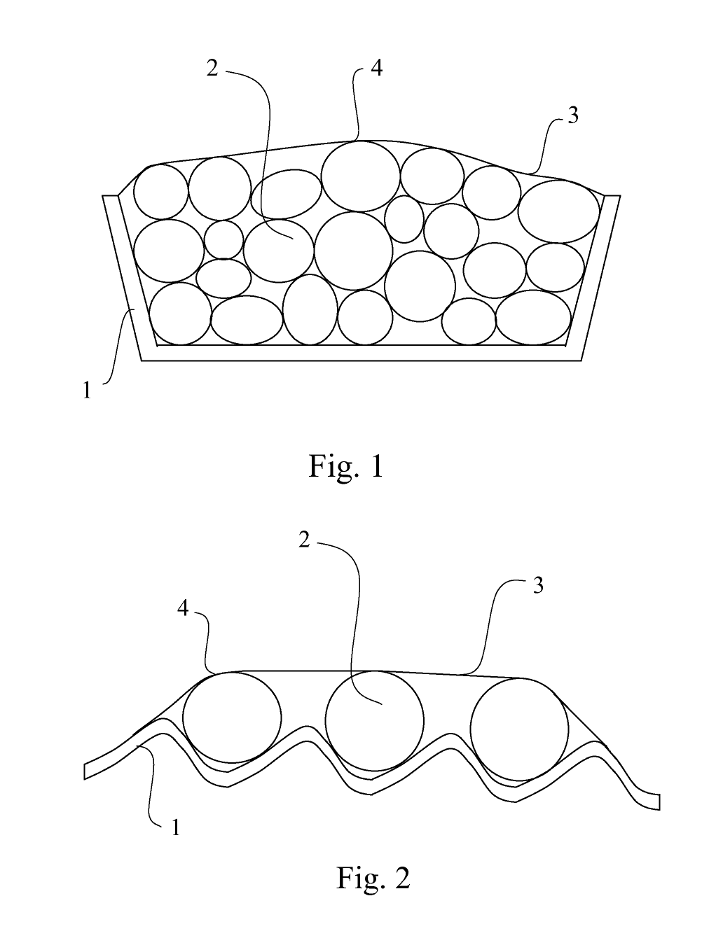

The invention relates to a fresh food produce wrapped in a film. In this way fresh food produce are often packed for transport and storage in the supermarket. Examples of such food products include vegetables, for example cauliflower, broccoli etc.

A problem is that the durability of the food products is limited by such a way of packing, because at the contact areas between the fresh food produce and the film the food produce rots or deteriorates in another way. For example cauliflowers are packed in this way and at the contact areas of the film and the cauliflower, the cauliflower show a discoloration, so that it cannot be sold anymore.

Above-mentioned problem is especially there in countries having a warm and humid climate, and where often the cooling during storage and transportation of fresh food produces is highly insufficient.

Aim of the invention is to diminish the rot, discoloration or any other way of deterioration at the contact areas of the food produce and the film.

Surprisingly this object is obtained if the film has a moisture vapour transmission rate (MVTR according to ISO 12572:2001, condition B at 1 bar, 38° C. and 50% relative humidity) of at least 350 g/m²·day.

In this way the decay of the food produce at the contact areas where the film is in contact with the food produce is retarded. This increases the shelf life of the produce.

Moisture vapour transmission rate (MVTR) is measured according to ISO 12572:1200, condition B at 1 bar, 38° C. and 50% relative humidity. The distance between the test sample and the desiccant is 10 mm.

The MVTR is preferably at least 800 g/m²·day, more preferably at least 1200 g/m²·day, even more preferably at least 1600 g/m²·day. In order to prevent drying out of the food product the MVTR is preferably at most 10.000 g/m²·day, more preferably at most 5000 g/m²·day.

The film is wrapped around the food produce at least partly, but preferably completely covering the food produce.

Because the film is wrapped around the food product, contact areas between the film and the produce have been formed.

It is possible that the film comprises perforations, preferably in the form of micro-perforations that may have a diameter of between 50 microns and 1000 microns, more preferably between 100 and 800 microns. The density of the perforations may be up to about 1000 per m², preferably up to about 500 m². Perforation may take place either in a continuous or in a batch process. For example, the perforation may be effected by contacting the film with one or more rollers comprising pins or needles to punch the micro-perforations. Perforation may also be effected by use of laser technology. The perforation may take place in line with the production of the film.

Preferably the film is produced from a polymer composition comprising a thermoplastic elastomer. One example is a thermoplastic copolyetheramide elastomer, comprising hard segments of a polyamide and soft segments of an aliphatic polyether. A further example of a suitable thermoplastic elastomer is a thermoplastic polyurethane (TPU). TPUs may be formed by the reaction between isocyanates, short chain doils or diamines and long chain diols or diamines.

Preferably as long chain diols polyetherdiols are used.

Preferably a thermoplastic copolyester elastomer (TPE) is used as the thermoplastic elastomer. More preferably a copolyether ester is used as the thermoplastic polyester elastomer.

The copolyether ester suitably contains hard segments that are built up from repeating units derived from at least one alkylene diol and at least one aromatic dicarboxylic acid or an ester thereof. As alternative to segment, also the term block is being used. The linear or cycloaliphatic alkylene diol contains generally 2-6 C-atoms, preferably 2-4 C-atoms. Examples thereof include ethylene glycol, propylene diol and butylene diol. Preferably propylene diol or butylene diol are used, more preferably 1,4-butylene diol. Examples of suitable aromatic dicarboxylic acids include terephthalic acid, 2,6-naphthalenedicarboxylic acid, 4,4′-biphenyldicarboxylic acid or combinations of these. The advantage thereof is that the resulting polyester is generally semi-crystalline with a melting point of above 150, preferably above 175, and more preferably of above 190° C. The hard segments may optionally further contain a minor amount of units derived from other dicarboxylic acids, for example isophthalic acid, which generally lowers the melting point of the polyester. The amount of other dicarboxylic acids is preferably limited to not more than 10, more preferably not more than 5 mol %, so as to ensure that, among other things, the crystallization of the copolyether ester is not adversely affected. The hard segment is preferably built up from ethylene terephthalate, propylene terephthalate, and in particular from butylene terephthalate as repeating units. Advantages of these readily available units include a high melting point, resulting in copolyether esters with good processing properties, excellent thermal and chemical resistance and good puncture resistance.

Suitable the copolyether ester contains soft segments of an aliphatic polyether. The polyether may have a glass-transition temperature (T_{g}) of below 0° C. Preferably, the T_{g} is below −20° C., more preferably below −40° C., and most preferably below −50° C. The molar mass of the segments may vary within a wide range, but preferably the molar mass is chosen between 400 and 6000 g/mol, more preferably between 500 and 4000 g/mol, and most preferably between 750 and 3000 g/mol. Suitable aliphatic polyethers include a poly(alkylene oxide)diol derived from an alkylene oxide of 2-6 C-atoms, preferably 2-4 C-atoms, or combinations thereof. Examples include poly(ethylene oxide)diol, poly(tetramethylene oxide)diol or poly(tetrahydrofuran)diol, poly(neopentylene oxide-co-tetramethylene oxide)diol, poly(propylene oxide)diol Preferably copolyether ester contains soft blocks derived from a polyethylene oxide-terminated poly(propylene oxide)diol.

The copolyether ester may further contain a compound with two or more functional groups that can react with an acid- or hydroxyl-group, acting as chain extension or chain branching agent, respectively. Examples of suitable chain extension agents include carbonylbislactams, diisocyanates and bisepoxides. Suitable chain branching agents include e.g. trimellitic acid, trimellitic acid anhydride and trimethylol propane. The amount and type of chain extension or branching agent is chosen such that a block copolyester of desirable melt viscosity is obtained. In general, the amount of a chain branching agent will not be higher than 6.0 equivalents per 100 moles of dicarboxylic acids presenting the copolyether ester. The copolyether ester can further contain the usual catalysts and stabilizers.

Examples and preparation of copolyether esters are for example described in Handbook of Thermoplastics, ed. O. Olabishi, Chapter 17, Marcel Dekker Inc., New York 1997, ISBN 0-8247-9797-3, in Thermoplastic Elastomers, 2nd Ed, Chapter 8, Carl Hanser Verlag (1996), ISBN 1-56990-205-4, in Encyclopedia of Polymer Science and Engineering, Vol. 12, Wiley & Sons, New York (1988), ISBN 0-471-80944, p. 75-117, and the references cited therein.

Particularly preferred is a copolyether ester with hard segments built up from butylene terephthalate units and soft segments derived from polyethylene oxide-terminated poly(propylene oxide)diol.

It is possible that the polymer composition of the film comprises a thermoplastic copolyester elastomer and a polyester, preferably polybutylene terephthalate.

The film may suitably be prepared by extrusion, for example by the blown film process or cast film process.

Food products that are preferably wrapped in the film include cauliflower, broccoli and spinache.

Especially good results are obtained in if the food produce is transported and/or stored at a temperature between 20 and 30° C., more specially between 22 and 30° C.

1. Fresh food produce wrapped in a film, wherein the film has a moisture vapour transmission rate (MVTR according to ISO 12572:2001, condition B at 1 bar, 38° C. and 50% relative humidity) of at least 350 g/m²·day.

2. Fresh food produce wrapped in a film according to claim 1, wherein the MVTR of the film is at least 800 g/m²·day.

3. Fresh food produce wrapped in a film according to claim 1, wherein the MVTR of the film is at least 1200 g/m2·day.

4. Fresh food produce wrapped in a film claim 1, wherein the film comprises a thermoplastic elastomer.

5. Fresh food produce wrapped in a film according to claim 4, wherein the thermoplastic elastomer is a thermoplastic copolyether ester elastomer.

6. Fresh food produce wrapped in a film according to claim 1, wherein the fresh food product is a cauliflower.

7. Transport and/or storage of the fresh food produce wrapped in a film according to claim 1, wherein the temperature of transport and/or storage is between 20 and 30° C.
